(19) United States
(12) Patent Application Publication
(10) Pub. No.: US 2017/0014759 A1
(43) Pub. Date: Jan. 19, 2017

(54) DEVICE AND METHOD FOR EXTRACTING A CHEMICAL COMPOUND IN ACID GASES

(71) Applicant: EREIE - ENERGY RESEARCH INNOVATION ENGINEERING, Palaiseau (FR)

(72) Inventors: Denis CLODIC, Palaiseau (FR); Samer MAARAOUI, Palaiseau (FR)

(73) Assignee: EREIE - ENERGY RESEARCH INNOVATION ENGINEERING, Palaiseau (FR)

(21) Appl. No.: 15/114,119

(22) PCT Filed: Jan. 12, 2015
(86) PCT No.: PCT/FR2015/050054

§ 371 Date: Jul. 26, 2016

(30) Foreign Application Priority Data
Feb. 5, 2014 (FR) 14 50893

(51) Int. Cl. B01D 53/50; B01D 53/78; B01D 53/60; B01D 53/68; B01D 53/00; B01D 53/34

(52) U.S. Cl. CPC B01D 53/504; B01D 53/002; B01D 53/343; B01D 53/346; B01D 53/60; B01D 53/68; B01D 53/78

(57) ABSTRACT

A device (1) for extracting a chemical compound from a gas of which the initial composition, the flow rate, and the partial pressure of the elements are known, this device comprising an inlet (7) via which the contaminated gas rushes in and an outlet (8) via which the decontaminated gas escapes, the device (1) comprising at least one decontamination level (2) defining an open passage for the gas, this decontamination level (2) comprising means (9) of injecting an acid solution into the gas.

The invention relates to the treatment of industrial acid gases, with condensate recycling and heat recycling.

These industrial gases arise from the combustion of solid fuels such as carbon, lignite, or household wastes. However, they are also generated from liquid fuels, such as the various kinds of heating oil, and from gaseous fuels such as natural gas or biogas. There are also combustion products from liquefied petroleum gases such as butane or propane, as well as mixed fumes consisting of flue gases and acid gases arising from reactions in which solid products (e.g., glass, cement, tiles, and bricks) of mineral industries are transformed.

The decontamination of acid gases containing nitrogen oxides

(NOₓ) and sulfur oxides (SOₓ) is known. Indeed, legislation imposes emission quotas for NOₓ and SOₓ, because these gases have a known impact on the environment and on health.

For example, nitrogen oxides (NOₓ) contribute to the greenhouse effect and are extremely toxic to humans because they enter the lungs, irritate the bronchial passages, and reduce the oxygen-carrying capacity of the blood.

The sulfur oxides (SOₓ), notably sulfur trioxide, are the main air pollutants responsible for acid rain. In the atmosphere, sulfur dioxide and sulfur trioxide react with water and hydrogen to produce nitrous acid (HNO₂) and sulfurous acid (H₂SO₃). In particular, these acid rains impair the normal development of species and plants by acidifying soils, surface waters, and the oceans and seas.

For this reason, the emission of such gases into the atmosphere is undesired. There are also other acid gas species, such as hydrofluoric acid and hydrogen chloride, which are quite toxic to humans.

In view of the damage that all of these acidic substances can cause, gas decontamination is a necessity.

Decontamination machines exist. They enable the extraction of acid gases by means of chemical reactions and temperature differences. This in particular is the object of U.S. Pat. No. 5,030,428 (METALLGESELLSCHAFT AG). What is taught in this document is the extraction of NOₓ and SO₂ from a gas. The device comprises a tower composed of a series of compartments that are sealed with respect to one another. The gases enter a first compartment into which sulfuric acid is sprayed, the purpose of this first step being to remove dust from the gases. The gases are then conducted outside the tower to be heated in a heat exchanger, after which they are mixed in a mixer with ammonia in order to form nitrogen (N₂) and water (H₂O). The gases deprived of NOₓ are then reheated and the SO₂ is oxidized to SO₃, after which the gas containing SO₃ is cooled to a temperature above the dew point of sulfuric acid and then conducted to the tower and into a second compartment. In this second compartment, the diluted sulfuric acid is vaporized and the SO₃ in the gases condenses. The gas then enters a third compartment of the tower, in which an aqueous solution is sprayed in order to remove fine particles.

The device described above is not energy efficient. The gases are heated and then cooled several times in order to reach the ideal conditions for the oxidation/reduction of the chemical elements at the expense of a considerable loss of energy.

The device is complex, because the gases are conducted outside the structure (the tower) in order to carry out the SO₂ oxidation reactions and the NOₓ reduction reactions.

The recovered condensates are contaminated by chemical elements other than those initially expected, because of the “natural” condensation effected in the tower.

As objectives of the invention, mention can be made of the following:
the effective decontamination of gases;
the recovery of condensates in pure or quasi-pure form;
the reuse of these condensates for decontamination and for other applications;
the recycling of heat from the temperature of the condensates or of the fumes;
the simplicity of the device;
the energy optimization of the overall device, with the heat of the industrial gases exploited to produce electricity by means of an Organic Rankine Cycle (ORC) machine.

Organic Rankine Cycle machines make it possible to produce electricity and energy in general by using temperatures as low as 80° C.

The terms “pure” and “quasi-pure” mean that a solution is recovered that comprises mainly the chemical elements that one wishes to recover.

In order to achieve these objectives, the decontamination is based on the dewpoint curves and the boiling point curves of each chemical compound of the gases.

In order to use good dewpoint and boiling point curves as a basis, the initial composition of the acid gases must therefore be known. The flow rate of the acid gases must also be known in order to regulate the cooling thereof.

The dewpoint curve gives the temperature at which the first drop of liquid appears for a chemical compound at a given pressure. The boiling point curve gives the temperature at which the first gas bubble appears for a chemical compound at a given pressure. Certain mixtures have an azeotropic point, like the mixture of H₂O+HNO₃ for a quantity of HNO₃ ranging from 30% to 40% in the mixture. When this point exists, it makes sense to exploit the properties of the mixture.

The azeotrope (azeotropic point) is the point where the chemical compound passes from a gas phase to a liquid phase at constant temperature.

Firstly, a device is proposed for extracting a chemical compound from a gas for which the initial composition, the flow rate and the partial pressure of its constituent chemical elements are known. This device comprises a casing that defines a volume through which the gas flows and that is equipped with an inlet at a first end via which the contaminated gas rushes in, and with an outlet at a second end via which the decontaminated gas escapes. The device comprises at least one decontamination level in the casing; this decontamination level in turn comprises means of injecting an acid solution into the gas. The decontamination level further comprises:
a condensate recovery tray disposed upstream of the injection means in relation to the gas movement direction, this recovery tray being dimensioned such that the recovery tray closes off the casing of the device, the recovery tray being permeable to the gases and impermeable to the liquids;
a recovery circuit comprising a recovery tank fluid-connected to the recovery tray for collecting the condensates on the one hand, and fluid-connected to the injection means for supplying the same with acid solution by means of a fluid pump on the other hand;
means of measuring the temperature of the gases entering the decontamination level and means of measuring the temperature of the acid solution;
a control unit in which a program is executed, this program being configured to carry out steps:
   of measuring the temperature of the gases entering the decontamination level;
   of measuring the temperature of the acid solution to be sprayed;
   of adjusting the temperature of the acid solution such that the gases are cooled to a temperature just below the azeotropic point of the chemical compound to be condensed;
   of spraying the acid solution into the decontamination level;
   of recovering the condensed chemical compound in the form of liquid phase condensates;
   of injecting the recovered solution into the casing of the decontamination level.

Various additional characteristics can be foreseen, alone or in combination:
the device comprises a filling located between the recovery tray and the means of injecting acid solution;
the recovery tank comprises a pH meter for measuring the acidity of the acid solution;
an electronic metering valve is arranged for injecting water into the recovery tank when the acidity of the acid solution exceeds a predetermined threshold;
the computer program is arranged for continuously measuring the pH of the acid solution and for injecting water into the acid solution when the acidity of the acid solution exceeds a predetermined threshold;
the recovery tank comprises a discharge for draining off the overflow;
the means of measuring the temperature of the acid solution are positioned upstream of the means of injecting the acid solution in relation to the movement direction of the acid solution;
a heat recycling circuit in which a heat transfer fluid circulates, the heat recycling circuit incorporating a heat exchanger disposed inside the decontamination level or in the recovery tank. The heat recycling circuit is arranged for heating a heat transfer fluid of an Organic Rankine Cycle for producing energy.

Secondly, a process is proposed for decontaminating and recycling the heat of a gas for which the initial composition, the flow rate and the partial pressure of the chemical elements are known. This process employs the device previously described and comprises the steps:
of measuring the temperature of the gases entering the decontamination level;
of measuring the temperature of the acid solution to be sprayed;
of adjusting the temperature of the acid solution such that the gases are cooled to a temperature just below the azeotropic point of the chemical compound to be condensed;
of spraying acid solution into the decontamination level in order to cool the gases;
of recovering the chemical compound condensed in the liquid phase;
of injecting recovered acid solution into the casing of the decontamination level;
   this process being repeated continuously in each decontamination level of the device.

Various additional characteristics can be foreseen, alone or in combination:
the pH of the acid solution is continuously measured and readjusted when the acidity exceeds a predetermined threshold;

This device and this process enable an effective decontamination, with recovery of the condensates in pure or quasi-pure form. Given their purity, it is furthermore possible to reuse these condensates while extracting the heat from the device by means of the heat recycling circuit. The device is thus more energy efficient than standard decontamination devices and consumes less acid solution.

Other objects and advantages of the invention will be seen from the following description of an embodiment, provided with reference to the appended drawings in which:

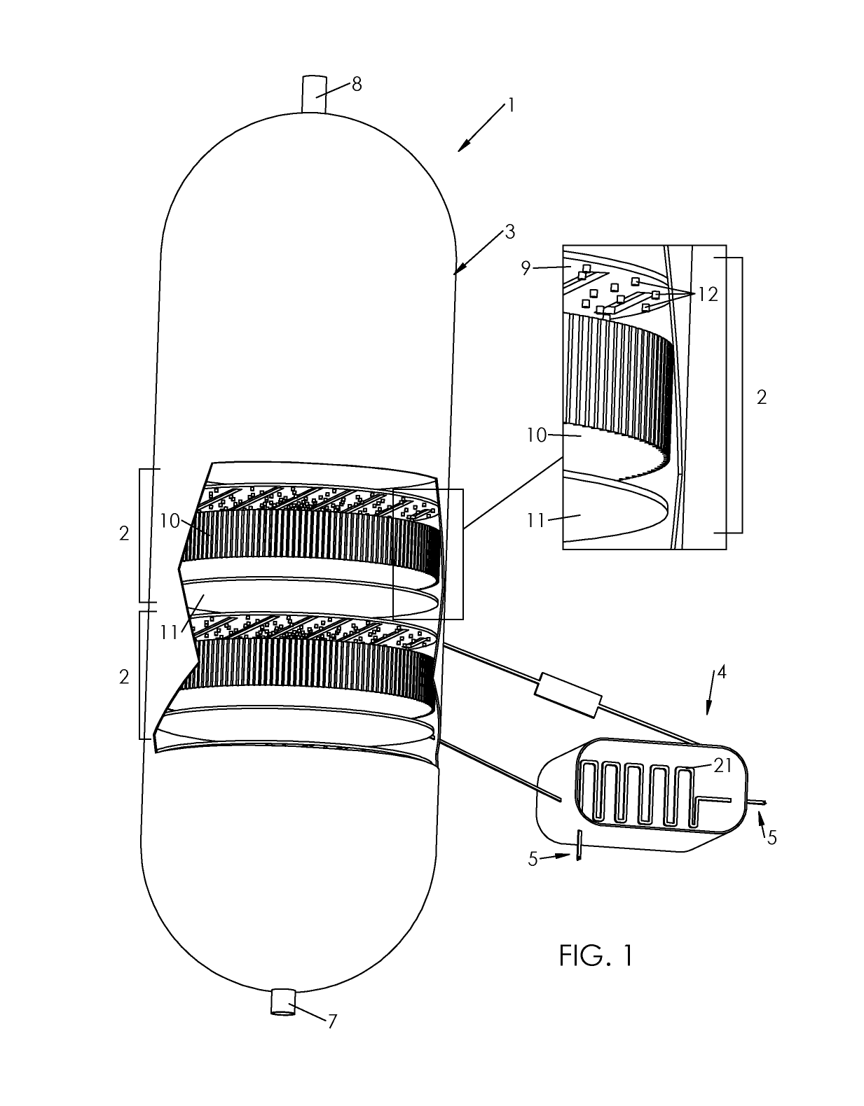

FIG. 1 is a perspective view of a device for extracting a chemical compound and for recycling heat, with a cutaway allowing the inside of the device to be viewed;

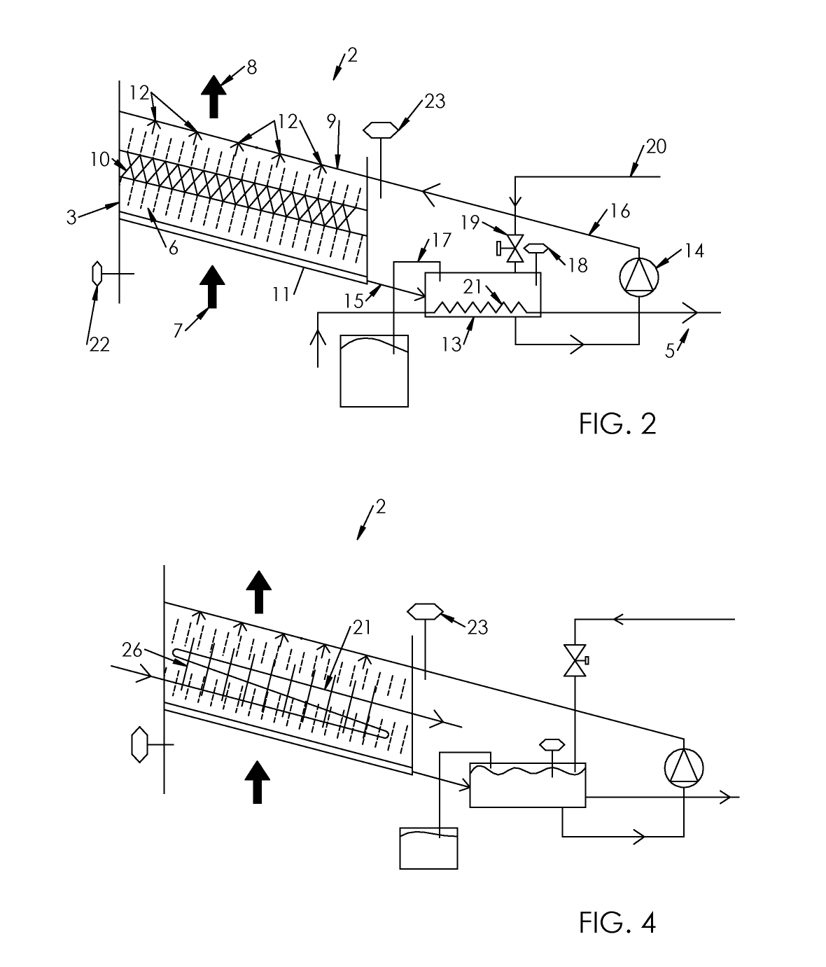

FIG. 2 is a diagrammatic illustration of a decontamination stage according to a first embodiment;

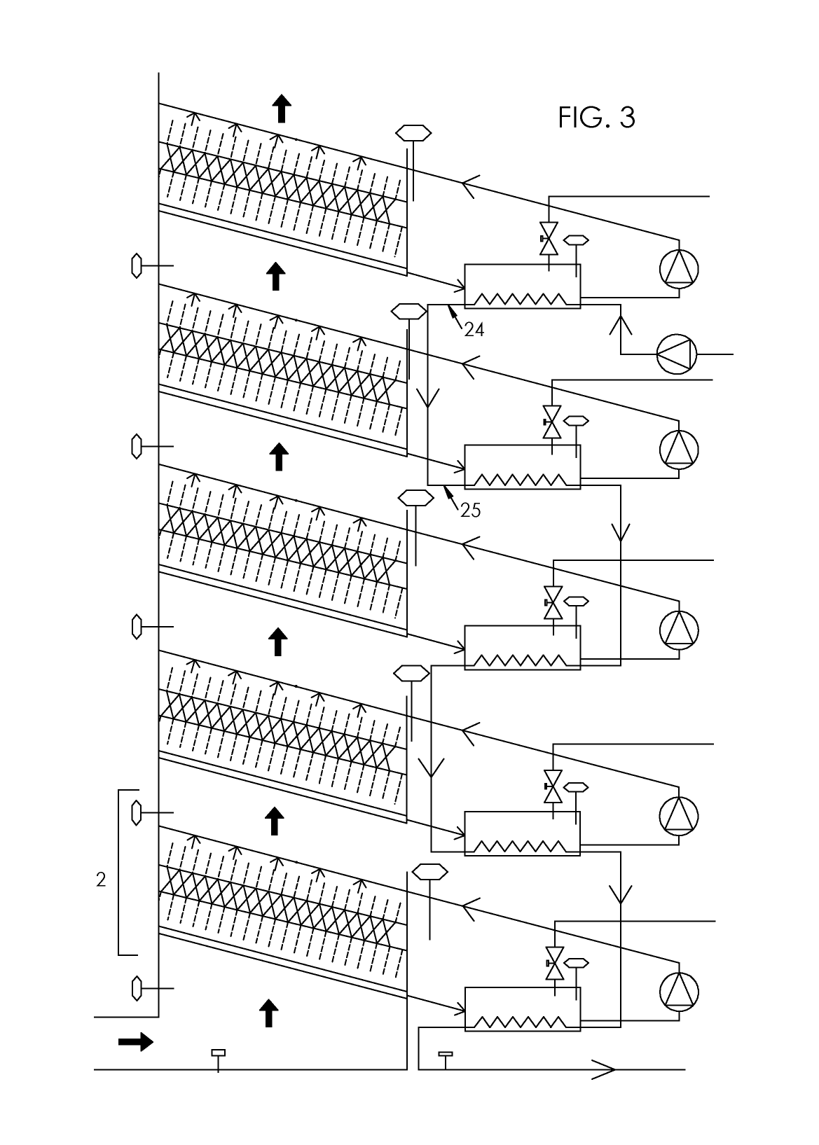

FIG. 3 is a diagrammatic illustration of a plurality of decontamination stages according to the first embodiment, connected to one another;

FIG. 4 is a diagrammatic illustration of a decontamination stage according to a second embodiment;

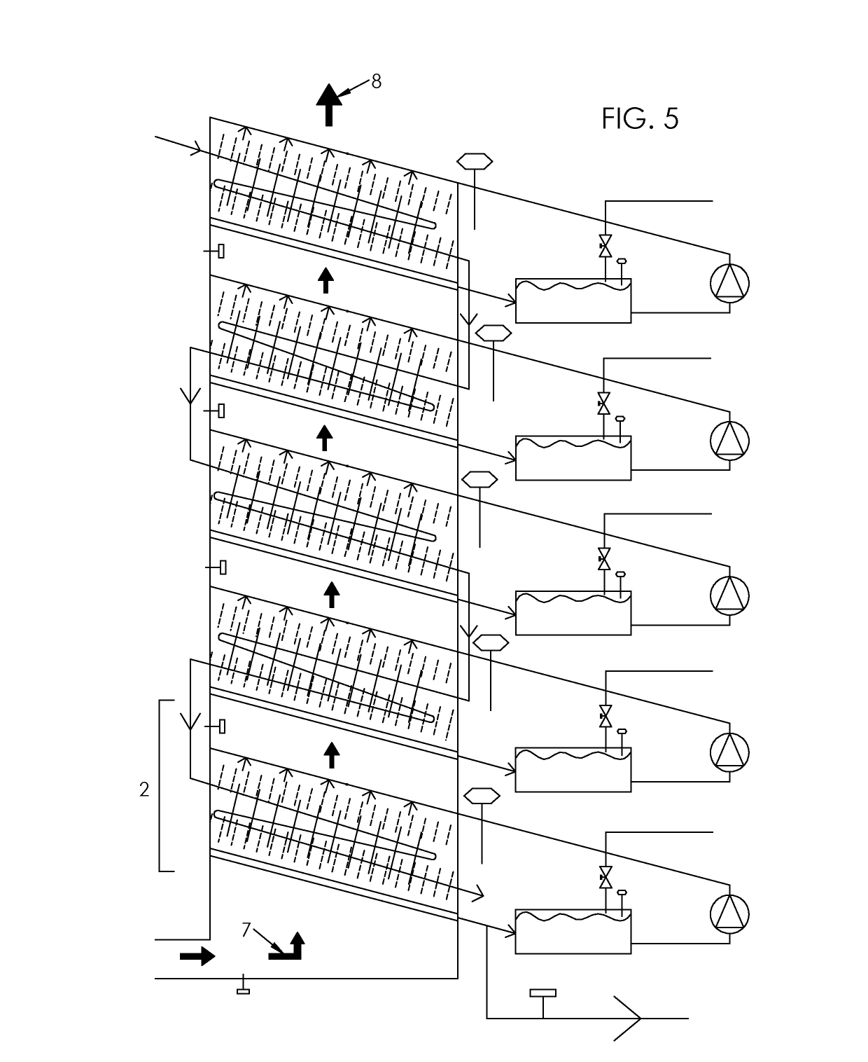

FIG. 5 is a diagrammatic illustration of a plurality of decontamination stages according to the second embodiment, connected to one another;

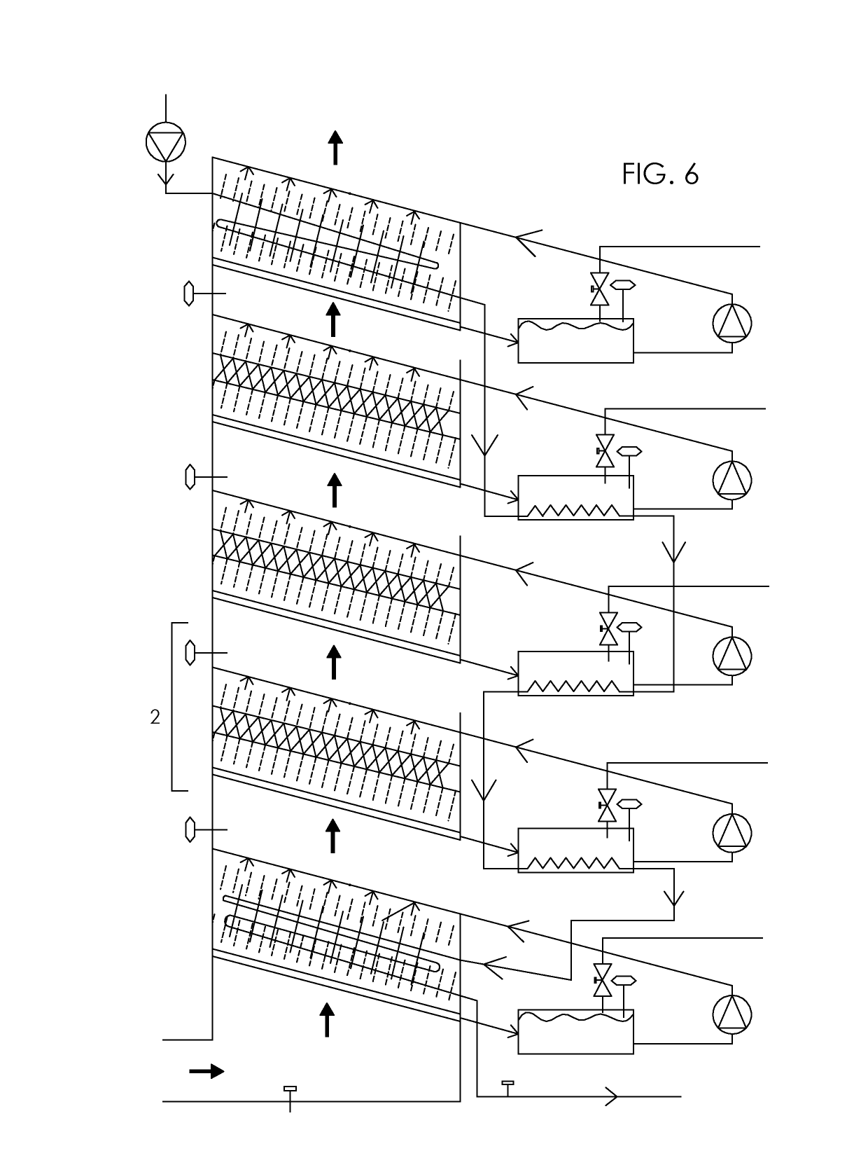

FIG. 6 is a diagrammatic illustration of a plurality of decontamination stages according to the first and the second embodiments, connected to one another;

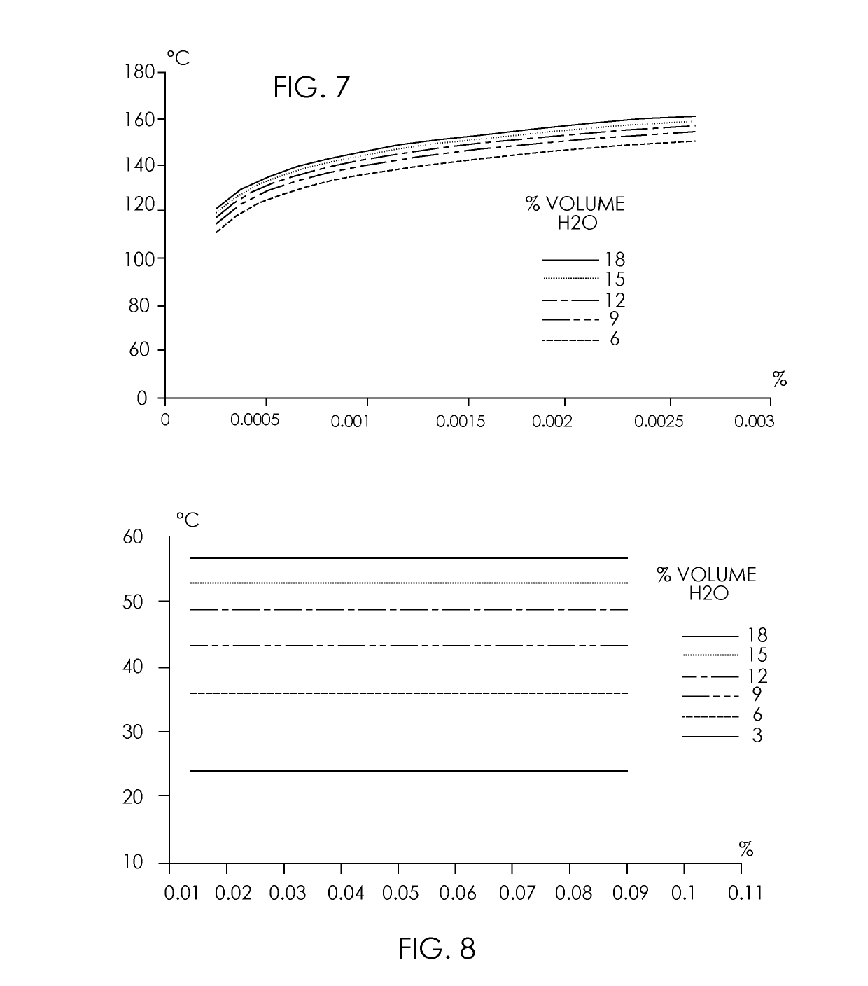

FIG. 7 is a graph of the sulfur trioxide (SO₃) dewpoint curves for different volumes of water in the gases to be treated, the y-axis giving the temperature and the x-axis giving the percentage of SO₃;

FIG. 8 is a graph of the sulfur dioxide (SO₂) dewpoint curves for different volumes of water in the gases to be treated, the y-axis giving the temperature and the x-axis giving the percentage of SO₂;

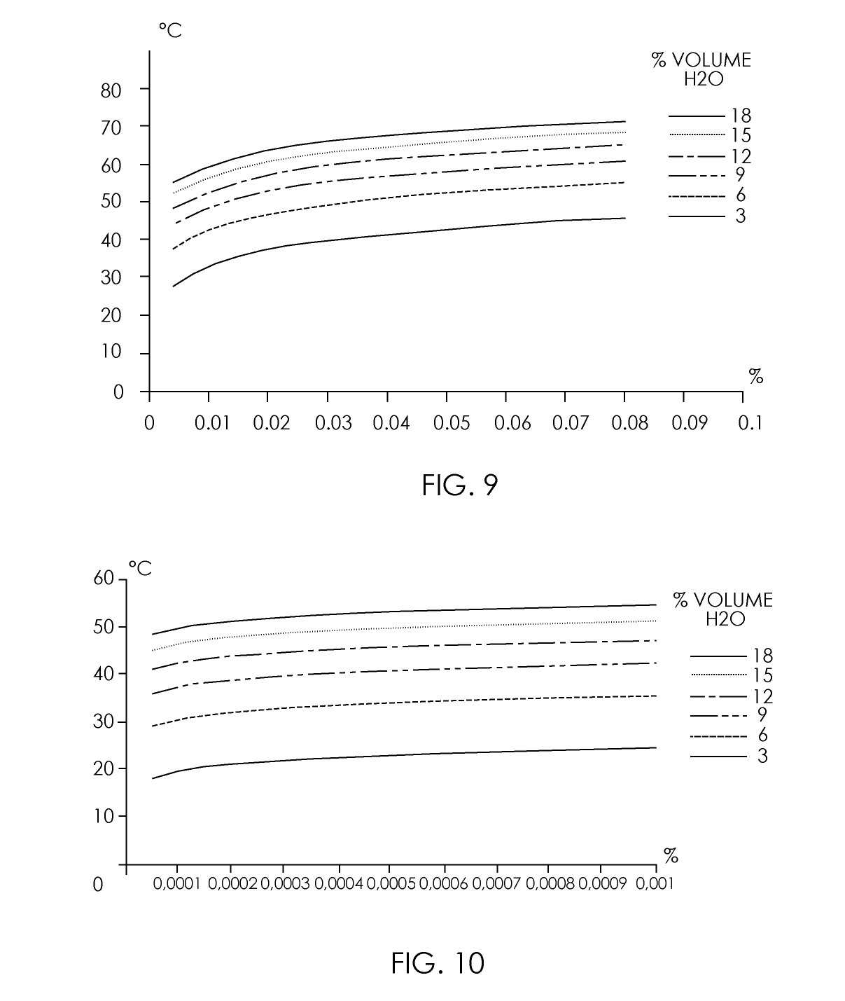

FIG. 9 is a graph of the nitrogen dioxide (NO₂) dewpoint curves for different volumes of water in the gases to be treated, the y-axis giving the temperature and the x-axis giving the percentage of NO₂;

FIG. 10 is a graph of the hydrogen chloride (HCl) dewpoint curves for different volumes of water in the gases to be treated, the y-axis giving the temperature and the x-axis giving the percentage of HCl;

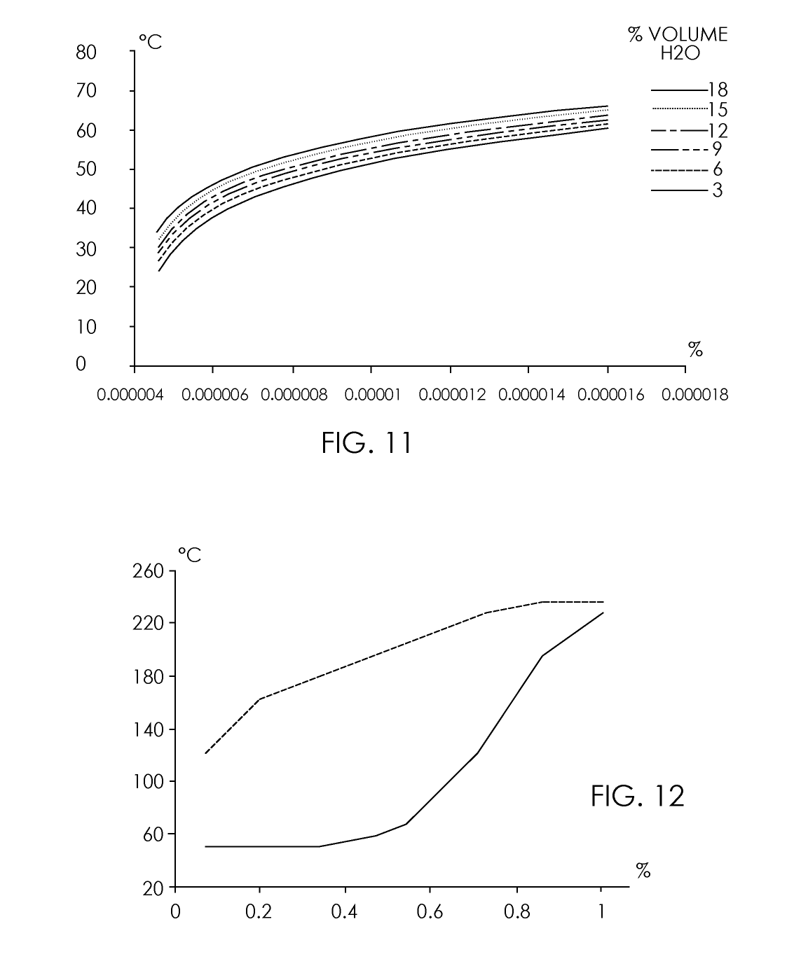

FIG. 11 is a graph of the hydrogen fluoride (HF) dewpoint curves for different volumes of water in the gases to be treated, the y-axis giving the temperature and the x-axis giving the percentage of HF;

FIG. 12 is a graph showing the dewpoint and boiling point curves of a sulfuric acid solution (H₂O+H₂SO₄) at a pressure of 0.17 bar, the y-axis giving the temperature and the x-axis giving the percentage of H₂SO₄;

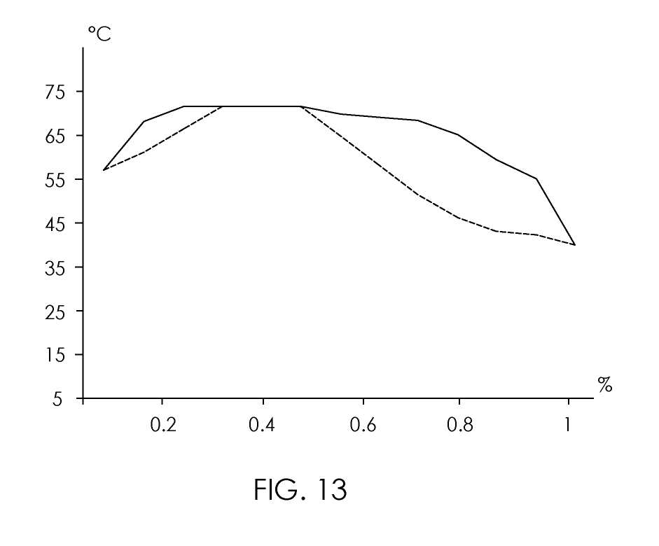

FIG. 13 is a graph showing the dewpoint and boiling point curves of a nitric acid solution (H₂O+HNO₃) at a pressure of 0.17 bar, the y-axis giving the temperature and the x-axis giving the percentage of HNO₃.

A device 1 for extracting a chemical compound and for recycling heat, henceforth designated [sic] “the device”, comprising a plurality of decontamination levels 2 is illustrated in FIG. 1. The device 1 comprises a casing 3 defining a volume. Although the casing 3 has a cylindrical cross section in the embodiment shown, it is possible for the casing 3 to define another cross section, for example, a square or rectangular one. Each decontamination level 2 comprises a condensate recovery circuit 4 and a heat recycling circuit 5. For the sake of clarity, only one decontamination level 2 comprising a condensate recovery circuit 4 and a heat recycling circuit 5 is shown in FIG. 1.

FIG. 2 illustrates a decontamination level 2 according to one embodiment of the device 1. The decontamination level 2 is an integral part of the device 1. Thus, the decontamination level 2 shares, with the device 1, an inlet 7 via which the contaminated gas rushes in, and an outlet 8 via which the at least partially decontaminated gas escapes, the casing 3 defining a cavity 6 through which a gas can pass.

The decontamination level 2 further comprises:
spray booms 9;
a filling 10; and
a recovery tray 11.

The spray booms 9 are located at the outlet 8 and can assume diverse forms. For example, the spray booms 9 can be in the form of tubes equipped with a series of suitably-sized orifices for spraying an acid solution inside the casing 3. As an alternative and as shown in the figures, the spraying can be carried out using injection nozzles 12.

The filling 10 is located in the casing 3, upstream of the spray booms 9 in relation to the movement direction of the gases. The filling has the form of a metal cuff (preference is given to a metal material given the prevailing temperatures of several hundred degrees Celsius at the highest point), the cross section of which is essentially identical to that of the casing 3 such that the gas inevitably passes through the cuff as it moves in the casing 3. The filling 10 makes it possible to increase the contact surface between the acid solution coming from the spray boom 9 and the fumes passing through the filling 10, thereby improving the heat and chemical exchanges between the acid solution and the gas while providing little resistance to the movement of the fluids.

The recovery tray 11 is located in the casing 3, upstream of the filling 10. The latter has the unique feature of being permeable to the gases and impermeable to the liquids. As is the case for the filling 10, the cross section of the recovery tray 11 is identical to that of the casing 3. Consequently, the liquid condensates coming from the filling 10 do not drop back into the gases that have passed beyond the recovery tray 11, as the condensates cannot filter through the latter owing to its impermeability.

The contaminated gases thus enter the decontamination level 2 by first passing through the recovery tray 11, and secondly through the filling 10, where heat and chemical exchanges take place in contact with the acid solution sprayed by the spray boom 9, then the at least partially decontaminated gas escapes via the outlet 8. In the filling 10, a portion of the gases are condensed under the effect of heat exchanges. Under the effect of gravity, these condensates fall with the sprayed acid solution into the recovery tray 11.

The decontamination level 2 further comprises a recovery tank 13, fluid-connected to the recovery tray 11 on the one hand, and to the spray boom 9 on the other hand. A fluid pump 14 enables the fluid to circulate from the recovery tank 13 to the spray boom 9. The acid solution containing the condensates is conducted from the recovery tray 11 to the recovery tank 13 via a recovery line 15, then it is sent to the spray boom 9 via a recycling line 16.

The recovery tank 13 comprises a discharge 17 designed to drain the overflow of the acid solution. Indeed, eventually the condensates extracted from the gases and recovered in the recovery tray 11 will inevitably fill the recovery tank 13 to capacity. The discharge thus enables the overflow to be drained into the sewage system, to a treatment unit, or even to a storage place for future use.

A pH meter 18 is used for measuring the acidity of the acid solution in the recovery tank 13. The hydrogen ion concentration can then be adjusted in the recovery tank 13 by means of an electronic metering valve 19 controlling the inflow of water from a regulating line 20. The hydrogen ion concentration tends to increase with the inflow of condensates, hence the pH of the solution needs to be lowered in order to maintain the initial parameters of the acid solution.

The decontamination level 2 is likewise provided with a heat recycling circuit 5 comprising, specifically, a heat exchanger 21 located in the chamber of the recovery tank 13. The heat of the condensates recovered in the recovery tank 13 is recycled by means of a heat exchanger 21. This heat is then used for other applications such as heating, for example.

In order to adjust the temperature of the sprayed acid solution, each decontamination level 2 is provided, at the inlet 7, with a first temperature sensor 22 for measuring the temperature of the gases, and with a second temperature sensor 23 located on the recycling line 16. The second temperature sensor 23 measures the temperature of the acid solution before the latter reaches the spray boom 9. The temperature of the sprayed acid solution can then be adjusted on the basis of the data provided by the temperature sensors 22, 23. The temperature of the sprayed acid solution is modulated by regulating the speed of the fluid pump 14.

FIG. 3 illustrates a device 1 for extracting a chemical compound and for recycling heat, which comprises a plurality of stacked decontamination levels 2. According to the embodiment illustrated, the device 1 comprises five decontamination levels.

For recovering an amount of heat energy over the greatest available temperature differential, the heat recycling circuits 5 are interconnected with one another. Thus, starting from the first heat recycling circuit, the outlet 24 of said circuit is connected to the inlet 25 of the second heat recycling circuit, and so forth, until the last heat recycling circuit.

In practice, the gases lose heat at each decontamination level 2, such that at the end of the process, i.e., at the last decontamination level, the temperature of the gases is minimal. For this reason, it is preferable to start the heat recycling from the heat recycling circuit of the last decontamination level. The heat transfer fluid will thus pass through the recovery tanks 13 of each decontamination level in succession, without losing heat. In other words, the temperature of the heat transfer fluid will vary in an increasing manner as the latter goes through the heat exchanger 21 of each heat recycling circuit, because the temperature of the condensates is rising from the last decontamination level to the first decontamination level.

The recovery of heat over the greatest possible temperature differential between the inlet and the outlet of the heat recycling circuit enables the recovery of the maximum amount of heat energy available in the gases to be treated. This is advantageous in terms of heat recycling and, in particular, in terms of supplying energy to an Organic Rankine Cycle.

An Organic Rankine Cycle (not shown in the figures) designed to produce electricity comprises an energy production circuit. A heat transfer fluid based on carbon chemistry circulates in this energy production circuit. Using the heat recovered by the heat recycling circuit of the device 1, the heat transfer fluid is heated up to its vaporization temperature in a heat exchanger. The heat transfer fluid thus vaporized actuates a turbine connected to a generator for producing electricity. The heat transfer fluid can then be used for a heating/air conditioning application before being reheated.

FIG. 4 illustrates a decontamination level 2 according to a second embodiment. The difference lies mainly in the arrangement of the heat recovery circuit 5.

In this embodiment, the filling 10 used in the preceding is replaced with a heat exchanger 21 equipped with fins 26. In this case, the heat recycling is effected by drawing the heat directly from contact with the gases rather than in the recovery tank 13 as in the preceding. The fins 26 replace the filling 10 of the preceding embodiment.

FIG. 5 shows device 1 for extracting a chemical compound and recycling heat, which comprises a plurality of decontamination levels 2 according to the second embodiment of FIG. 4. As in the first embodiment, and for the same reasons as previously explained, the heat recycling is effected from top to bottom, i.e., by first drawing out the heat in the last decontamination level 2 and then finishing in the first decontamination level.

It should be noted that the decontamination is based on the dewpoint curves of the various chemical compounds present in the gases. It is for this reason that the composition of the gas must be at least approximately known. The greater the precision with which the composition of the gases is known, the more effective the decontamination will be.

The example of an acid gas containing the sulfur oxides SO₂, SO₃, the nitrogen oxides NO, NO₂, and also chlorine and fluorine will be discussed in the following.

FIGS. 7-11 illustrate, respectively, the dewpoint curves of sulfur trioxide (SO₃), sulfur dioxide (SO₂), nitrogen dioxide (NO₂), hydrogen chloride (HCl), and hydrogen fluoride (HF).

It can be seen that sulfur trioxide has the highest dewpoints. In other words, condensation takes place at a higher temperature relative to the other chemical compounds.

FIG. 12 shows that a pure sulfuric acid solution condenses at a temperature of 240° C., for a partial pressure of water and sulfuric acid of 0.17 bar in the gases to be treated.

The controlled cooling of the gas in the first decontamination level 2 thus brings about the condensation of sulfuric acid molecules. In other words, a solution, of which the temperature is controlled, is sprayed into the first decontamination level 2. This precise regulation is effected on the basis of the temperature of the gases on entering the decontamination level 2 and the temperature of the acid solution in the recycling line 16. The cooling of the gases is thus precisely controlled.

Since temperature is not the only variable, the chemical composition of the sprayed acid solution is also taken into account. Thus, by choosing the temperature in a rational manner, the SO₂ contained in the gases is oxidized to SO₃ starting from the first decontamination level 2.

By spraying a sulfuric acid solution (H₂O+H₂SO₄), the chemical exchanges taking place in the filling 10 in this example involve the production of SO₃ (by water reacting with SO₂), which condenses in the first decontamination level 2 due to the cooling applied by the spraying at a temperature regulated by the fluid pump speed. By simultaneously controlling the composition of the acid solution, as well as the temperature and concentration thereof, it thus becomes possible to condense just one chemical compound, wherein in this particular case and in this decontamination level 2, the sulfur trioxide instantaneously becomes sulfuric acid upon contact with water. It is thus possible to obtain a pure, or at least quasi-pure, condensate for the benefit of the recycling of the acid solution since, owing to the metering valve, it is not necessary to readjust the concentration of this solution as often as it would be in the case where several chemical compounds are recovered in the recovery tray. In this particular case, SO₃ is recovered which, as already mentioned, forms sulfuric acid instantly with water.

The SO₃ recovered in the recovery tray 11 and which was transformed into sulfuric acid is then re-injected into the decontamination level 2. In conjunction therewith, the pH of the acid solution is measured in the recovery tank 13. The pH increases with the inflow of condensates. The electronic metering valve 19 adjusts the pH simply by adding water.

This technique is repeated at each level 2 of the extraction device 1 by chilling the gases in order to condense the target chemical compounds on the one hand, and by modifying the chemical composition of the gases by the precise choice of the sprayed acid solution on the other hand. The acid solution (which contains water) also changes the water content of the gases to be treated. It is then possible to control the water content in a rational manner for modifying the condensation temperature of an acid gas. It can thus be seen in FIG. 12 that by increasing the water content in the gases to be treated (which consequently brings about a percent reduction of the sulfuric acid content in the gases to be treated in relation to the water content), the condensation temperature of the sulfuric acid is lowered. It is therefore understood that varying the water content in the gases to be treated makes it possible to modify the condensation temperature of the chemical elements that one wishes to recover.

Nevertheless, the task becomes complicated when it comes to condensing gases at a lower temperature. In FIGS. 8-10, it can be discerned that the condensation temperatures of NO₂, HCl, and SO₂ are close to one another. In a second level, the condensates will be recovered in the form of a mixture of several chemical compounds, because a simple cooling of the gases will necessarily involve the condensation of several species present therein.

In order to limit the mixtures of acids, and for recovering condensates that are as pure as possible, an optimum adjustment of the spray temperature and of the water content of the gas to be treated is required in order to cool the gases accurately below the condensation temperature of the chemical compound that one wishes to condense.

FIG. 13 shows a phase diagram of a solution of water and nitric acid. The azeotrope of this solution is reached with 30-40% by mass of nitric acid in the solution at a temperature of about 70° C.

The NO₂ present in the gases oxidizes with the acid solution containing water to form nitrogen trioxide. Thus, in order to condense the NO₃ present in the gases following the chemical reaction, it suffices to be positioned just below the azeotropic point of the nitric acid solution in order to effect the condensation of the nitric acid without going through a transitional state (liquid phase+vapor phase).

This technique is then repeated for extracting fluorine and chlorine. It can be seen that the dewpoint temperatures of HCl and HF are close to each other. By knowing the dewpoint associated with the water vapor, fluorine gas, or chlorine gas concentrations, the latter can then be condensed separately by precisely regulating the spray solution temperature to just below the respective dewpoints. Pure or quasi-pure condensates of chlorine in one decontamination level, and of fluorine in another decontamination level, will thus be obtained.

The azeotropic point is an exception that is characteristic to certain mixtures. When this point exists, it is worthwhile condensing the acid gases that one wishes to recover at this point. In practice, this involves identifying this point by knowing the characteristics of the gases to be treated. The cooling of the contaminated gases is then regulated such that the temperature is lowered to just below the azeotropic point. The condensation thus takes place at a constant temperature.

As previously mentioned, and in conjunction with the decontamination of the gases, the heat of the condensates is made available for other applications by the heat recycling circuit 5. In one embodiment, the heat transfer fluid flows through each recovery tank 13 in countercurrent fashion starting from the last recovery tank, in other words, from the recovery tank 13 in which the condensates exhibit the lowest temperature compared to the condensates of the other recovery tanks. It is thus possible to optimize the temperature gain of the heat transfer fluid.

This process is carried out by a control unit (not shown) in which a computer program is implemented. The computer program is designed to carry out the steps:
of measuring the temperature of the gases at the inlet 7 of the decontamination level 2 by means of the first temperature sensor 22;
of measuring the temperature of the acid solution to be sprayed into the decontamination level 2 by means of the second temperature sensor 23;
of adjusting the temperature of the acid solution such that the gases are cooled to a temperature just below the dewpoint of the chemical compound to be condensed;
of spraying acid solution into the decontamination level 2 by means of the spray boom 9 in order to cool the gases;
of recovering the condensed chemical compound in the form of liquid phase condensates in the recovery tray 11;
of injecting recovered acid solution into the casing 3 of the decontamination level 2.

The computer program is furthermore designed for continuously measuring the acidity of the acid solution contained in the recovery tank 13. When the acidity exceeds a predetermined threshold, the computer program commands the electronic metering valve 19 to open in order to dilute the acid solution and thereby lower its pH.

Among the advantages procured by the device, mention may be made of the following:
the recycling of condensates in pure or quasi-pure form; thus, it is not necessary to continuously add acid solution, because the acidity of the solution is maintained by means of the condensate and its pH is adjusted by adding water to the recovery tank 13;
the possibility of recovering a portion of the condensates for other applications;
the possibility of utilizing the heat of the condensates in different applications associated with the process or for producing electricity by means of Organic Rankine Cycle systems.

1. A device (1) for extracting a chemical compound from an acid gas of which the initial composition, the flow rate, and the partial pressure of the constituent elements are known, this device comprising a casing (3) defining a volume through which the gas passes, and equipped, on a first end, with an inlet (7) via which the contaminated gas rushes in and, on a second end, with an outlet (8) via which the decontaminated gas escapes, the device comprising at least one decontamination level (2) in the casing (3), this decontamination level (2) comprising means (9) of injecting an acid solution into the gas,
characterized in that the decontamination level (2) comprises:
a condensate recovery tray (11) disposed upstream of the injection means (9) in relation to the gas movement direction, this recovery tray (11) being dimensioned such that the recovery tray (11) closes off the casing (3) of the device (1), the recovery tray (11) being permeable to the gases and impermeable to the liquids;
a recovery circuit (4) comprising a recovery tank (13) fluid-connected to the recovery tray (11) for collecting the condensates on the one hand, and fluid-connected to the injection means (9) for supplying the same with acid solution by means of a fluid pump (14) on the other hand;
means (22) of measuring the temperature of the gases entering the decontamination level and means (23) of measuring the temperature of the acid solution;
a control unit in which a program is executed, this program being configured to carry out steps:
of measuring the temperature of the gases entering the decontamination level;
of measuring the temperature of the acid solution to be sprayed;
of adjusting the temperature of the acid solution such that the gases are cooled to a temperature just below the dewpoint or the azeotropic point of the chemical compound to be condensed;
of spraying acid solution into the decontamination level (2);
of recovering the condensed chemical compound in the form of liquid phase condensates;
of injecting recovered solution into the casing of the decontamination level.

2. The device (1) for extracting a chemical compound according to claim 1, characterized in that it comprises a filling (10) located between the recovery tray (11) and the means (9) of injecting the acid solution.

3. The device (1) for extracting a chemical compound according to claim 1, characterized in that the recovery tank (13) comprises a pH meter (18) for measuring the acidity of the acid solution.

4. The device (1) for extracting a chemical compound according to claim 1, characterized in that an electronic metering valve (19) is arranged for injecting water into the recovery tank (13) when the acidity of the acid solution exceeds a predetermined threshold.

5. The device (1) for extracting a chemical compound according to claim 4, characterized in that the program is designed for continuously measuring the pH of the acid solution and for injecting water into the acid solution when the acidity of the acid solution exceeds a predetermined threshold.

6. The device (1) for extracting a chemical compound according to claim 1, characterized in that the recovery tank (13) comprises a discharge (17) for draining off the overflow.

7. The device (1) for extracting a chemical compound according to claim 1, characterized in that the means (23) of measuring the temperature of the acid solution are positioned upstream of the means of injecting the acid solution in relation to the movement direction of the acid solution.

8. The device (1) for extracting a chemical compound according to claim 1, characterized in that said device comprises a heat recycling circuit (5) in which a heat transfer fluid circulates, the heat recycling circuit (5) incorporating a heat exchanger (21) disposed inside the decontamination level (2) or in the recovery tank (13), the heat recycling circuit (5) being arranged for heating a heat transfer fluid of an Organic Rankine Cycle for producing energy.

9. A process for extracting a chemical compound from an acid gas of which the initial composition, the flow rate, and the partial pressure of the chemical elements are known, this process employing the device according to claim 1, this process comprising the steps:
of measuring the temperature of the gases entering the decontamination level (2);
of measuring the temperature of the acid solution to be sprayed;
of adjusting the temperature of the acid solution such that the gases are cooled to a temperature just below the dewpoint or the azeotropic point of the chemical compound to be condensed;
of spraying acid solution into the decontamination level (2) in order to cool the gases;
of recovering the condensed chemical compound in the form of liquid phase condensates;
of injecting recovered acid solution into the casing (3) of the decontamination level (2);
this process being repeated continuously in each decontamination level (2) of the device (1).

10. The decontamination and heat recycling process according to claim 9, characterized in that the pH of the acid solution is measured continuously and readjusted when the acidity exceeds a predetermined threshold.
